(19) United States
(12) Patent Application Publication
(10) Pub. No.: US 2007/0118693 A1
(43) Pub. Date: May 24, 2007

(54) Method, apparatus and computer program product for cache restoration in a storage system

(75) Inventors: Karen W. Brannon, Palo Alto, CA (US); Yin Chen, Santa Clara, CA (US)

Correspondence Address: IBM ALMADEN (AVE);c/o LAW OFFICE OF ANTHONY ENGLAND, P.O. BOX 5307, AUSTIN, TX, 78763, US

(73) Assignee: International Business Machines Cor

(21) Appl. No.: 11/282,201

(22) Filed: Nov. 19, 2005

(51) Int. Cl. G06F 12/00; G06F 12/16

(52) U.S. Cl. 711/118; 711/162

(57) ABSTRACT

A storage system has a cache and a main storage for longer term storage. The main storage has first files stored therein. First copies of a subset of the first files are cached responsive to user requests for ones of the first files. In a predetermined, set-aside portion of the main storage, substantially all the cached files are copied, so that the main storage includes the first files and second copies of substantially all of the subset of the first files. The second copies are in a more compact data structure in the set-aside portion than is the subset of the first files in a non-set-aside portion of the main storage. Also, ones of the second copies of the subset of the first files are loaded to the cache from the set-aside portion of the main storage in response to a loss of ones of the files in the cache.

### BACKGROUND

1. Field of the Invention

The present invention concerns data storage systems, and, more particularly, concerns efficient restoration of data in such storage systems.

2. Description of Related Art

Businesses are dealing with ever increasing amounts of electronically stored data. (As this term is used herein, “electronically” stored data includes optically stored data.) This is not only because of the usefulness of such data to enterprises, but also due to regulatory requirements, which may not only mandate businesses to safely maintain more and more data, but may even mandate that data must be recoverable within 24 hours after a failure.

“Reference storage systems” are commonly used to store such data. A reference storage system having a stack of software and hardware system components forming a hierarchy is known as hierarchical storage management (“HSM”). A storage system 100 is shown in block diagram form in FIG. 1. In an HSM-organized reference storage system, users typically access a front end 110, which may be referred to as a content management (“CM”) system. The front end 110 of system 100 maintains popular objects/files in a disk cache 120, which is typically organized as a file system. For good performance, the CM disk cache 120 (shown figuratively as a single disk) is often configured on fast, relatively expensive disks having a collective storage capacity of hundreds of gigabytes (“GB's”), or even terabytes (“TB's”), possibly holding data accumulated over an interval of several weeks. The HSM-organized reference storage system stores permanent copy of files in a cheaper, slower, storage “back end,” such as tape storage, which is typically even more reliable than the storage media of front end 110. A storage back end 150 is shown in FIG. 1, including tape storage 170. Such a back end 150 may have a total reference data set with tens, or even hundreds, of TB's of stored data.

Particularly given a storage system 100 of this size, it presents a significant problem if a disk cache 120 is lost due to a failure, such as a disk crash. One conventional way to deal with this problem relies on expensive replication, such as by one or more redundant arrays of independent disks. Another conventional way to deal with this problem involves time consuming procedures for backing up data periodically. While maintaining a backup enables recovery of a disk cache 120 after a failure, it is still problematic that the restoration process can be time consuming and tedious. It may take days to restore a large disk cache 120 in its entirety from a back end 150 tape storage 170.

### SUMMARY OF THE INVENTION

The present invention addresses the foregoing problem. According to a method form of the invention, a method concerns a storage system having a cache and a main storage for longer term storage, with the main storage of the system having first files stored therein. The method includes caching first copies of a subset of the first files in the cache responsive to user requests for ones of the first files. In a predetermined, set-aside portion of the main storage, substantially all the cached files are copied, so that the main storage includes the first files and second copies of substantially all of the subset of the first files. The second copies are in a more compact data structure in the set-aside portion than is the subset of the first files in a non-set-aside portion of the main storage. Also, the method includes loading ones of the second copies of the subset of the first files to the cache from the set-aside portion of the main storage in response to a loss of ones of the files in the cache.

According to an apparatus form of the invention, a storage system includes main storage having first files therein on a tangible, computer-readable medium. The storage system also includes a cache having cached files stored therein on a tangible, computer-readable medium, the cached files being first copies of a subset of the first files of the main storage. The storage system further includes a controller for the main storage having copy logic operable to copy, into a predetermined, set-aside portion of the main storage, substantially all the cached files, such that the main storage includes the first files and second copies of substantially all of the subset of the first files, wherein the second copies are in a more compact data structure in the set-aside portion of the main storage than is the subset of the first files in a non-set-aside portion of the main storage and ones of the second copies of the subset of the first files may be loaded to the cache from the set-aside portion of the main storage in response to a loss of ones of the files in the cache.

According to another form of the invention, a computer program product concerns controlling certain storage in a storage system having a cache and a main storage for longer term storage. The main storage of the system has first files stored therein and first copies of a subset of the first files are cached in the cache responsive to user requests for ones of the first files. The computer program product has instructions stored on a tangible, computer-readable medium. The instructions include instructions for copying, in a predetermined, set-aside portion of the main storage, substantially all the cached files, so that the main storage includes the first files and second copies of substantially all of the subset of the first files. The second copies are in a more compact data structure in the set-aside portion than is the subset of the first files in a non-set-aside portion of the main storage. The computer program product also includes instructions for loading ones of the second copies of the subset of the first files to the cache from the set-aside portion of the main storage in response to a loss of ones of the files in the cache.

Other variations, objects, advantages, and forms of the invention will become apparent upon reading the following detailed description and upon reference to the accompanying drawings.

### BRIEF DESCRIPTION OF THE DRAWINGS

The foregoing and other objects, aspects and advantages will be better understood from the following detailed description of a preferred embodiment(s) of the invention with reference to the accompanying drawings. The same reference numbers are used throughout the FIG's to reference like components and features. In the drawings:

FIG. 1 illustrates a prior art storage system.

FIG. 2 illustrates a storage system according to the present invention.

FIGS. 3A-3E illustrate an example sequence of operations, according to an embodiment of the present invention.

FIG. 4 illustrates certain additional details of the Approximate Disk Cache controller of FIG. 2, according to an embodiment of the present invention.

FIG. 5 illustrates certain aspects of the storage system of FIG. 2 that particularly relate to the compact nature of the Approximate Disk Cache and that are particularly advantageous for bulk loading, according to an embodiment of the present invention.

FIG. 6 illustrates a computer system that is applicable for the controller of FIGS. 2 and 4, according to an embodiment of the present invention.

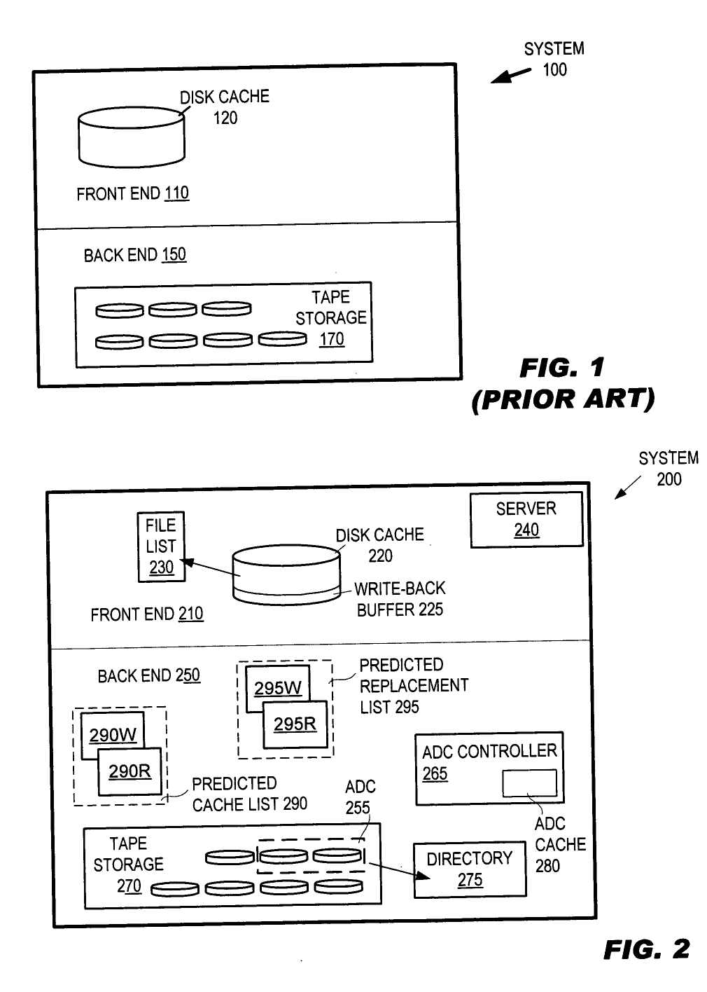

### DETAILED DESCRIPTION OF PREFERRED EMBODIMENTS OF THE INVENTION

In the following detailed description of the preferred embodiments, reference is made to the accompanying drawings illustrating embodiments in which the invention may be practiced. It should be understood that other embodiments may be utilized and changes may be made without departing from the scope of the present invention. The drawings and detailed description are not intended to limit the invention to the particular form disclosed. On the contrary, the intention is to cover all modifications, equivalents and alternatives falling within the spirit and scope of the present invention as defined by the appended claims. Headings herein are not intended to limit the subject matter in any way.

Overview

Referring now to FIG. 2, storage system 200 is shown, according to an embodiment of the present invention. In the event of data loss in disk cache 220, hundreds of GB's, or even TB's, of disk cache 220 must be quickly restored from a slow storage back end 250. (Although disk cache 220 is figuratively shown as a single disk, it should be understood that it may span multiple disks. Also, it should be understood that cache 220 is not necessarily limited to disk storage.)

With ever increasing demands for voluminous amounts of stored data, this problem or restoring a large disk cache arises more and more often. One way the present invention addresses the problem is by making storage back end 250 smarter. That is, in order to facilitate fast restoration of disk cache 220, a smart storage back end 250 has an ADC controller 265 that continually keeps data organized in the back end in a useful data structure 255 that is referred to herein as an approximate disk cache (“ADC”). ADC controller 265 may be implemented, for example, by an application-specific integrated circuitry. ADC controller 265 builds ADC 255 and stores it on a tangible, computer-readable medium, which is shown as tape storage 270 in the illustrated embodiment of the present invention,

The manner of organizing ADC 255 in storage back end 250 is facilitated by ADC controller 265 getting information on a timely and opportune basis about what files are in disk cache 220. In one aspect of one embodiment of the present invention, storage back end 250 uses standard Posix API to gain knowledge of disk cache 220 content, i.e., what files are in disk cache 220, without internal changes to disk cache 220, thereby providing a low-cost solution. In another aspect of the present embodiment of the invention, information needed for efficiently building a compact ADC 255 is extracted from disk cache 220 on a timely and opportune basis, in one respect, by ADC controller 265 in storage back end 250 monitoring and taking advantage of storage access patterns. Also, controller 265 examines differences between observed disk cache 220 structure and the ADC 255 data structure in order to accurately and adaptively predict what might be cached by disk cache 220 in the future. This leads to a simple, efficient, low-cost disk cache 220 restoration method permitting the front end 210 to bulk-load the disk cache 220 from the ADC 255 after failed disks in front end 210 have been replaced. This bulk-loading is advantageous because it is done from sequential storage locations in back end 250 tape storage 270, without random I/O's that would otherwise slow data transfer. (Although storage 270 is depicted herein as tape storage, it should be understood that it is not necessarily limited to tape storage. It may, for example, include disk storage.) Hence disk cache 220 restoration can be done in minutes, or at most in a few hours, rather than possibly days.

This arrangement for keeping ADC 255 organized in back end 250 and restoring of disk cache 220 by bulk-loading from ADC 255 adds little hardware cost or management overhead, since it utilizes cheap and spare storage resources in storage back end 250, i.e., tape storage 270 in the presently illustrated embodiment of the invention. (Although ADC 255 is part of back end storage 270, it should be understood that herein ADC 255 and storage 270 shall usually be considered separate in terms of accesses by front end 210. That is, front end 210 requests for data from back end 250 are usually requests to the non-ADC 255 portion of tape storage 270, unless restoring disk cache 220. Consequently, references herein to tape storage 270 should generally be taken as references to the non-ADC 255 portion of storage 270, unless clearly indicated otherwise.)

Although it is advantageous to keep ADC 255 organized as an approximate version of disk cache 220, this arrangement does present several difficulties. For one thing, it adds overhead that could impede overall storage system 200 performance. One way the present invention mitigates this overhead problem is by taking advantage of occasions when front end 210 reads data from back end storage 270, i.e., using these occasions for back end 250 to concurrently update ADC 255. However, it would present another problem if the only time back end 250 were to build ADC 255 was when front end 210 reads data from back end 250. That is, if disk cache 220 has a write-back buffer 225, as shown, a user may write a file to front end 210, which temporarily stores the file in write-back buffer 225, and then the user may read the file from write-back buffer 225 before front end 210 writes the file from buffer 225 to back end 250. In this situation, the occasion of a read access from front end 210 to back end 250 does not occur. Consequently, ADC controller 265 also builds and updates ADC 255 responsive to passage of time or some other event or events besides merely read accesses of back end storage 270 by front end 210.

Another problem that arises in keeping ADC 255 current is that back end 250 does not necessarily know what front end 210 deletes from the disk cache 220 when disk cache 220 gets full and front end 210 makes room in disk cache 220 for new files. One way the present invention deals with this problem is for ADC controller 265 to get a list 230 of what is in disk cache 220 from time to time (such as, for example, twice a day), compare this list 230 to a directory 275 of what is in ADC 255, and catch up on updating ADC 255, so that ADC more nearly matches the actual disk cache 220. This catching up may be done in the background.

Building ADC

In order for storage back end 250 to assemble ADC 255, ADC controller 265 must know what files are in disk cache 220. This is knowledge typically only known to front end 210 internals. However, since disk cache 220 is conventionally organized according to a file system partition, as long as the file system structure is exposed to storage back end 250, ADC controller 265 can figure out what is cached in disk cache 220. That is, ADC controller 265 extracts a file list 230 from disk cache 220 with standard Posix API or common commands such as find or readdir, all of which may be done without front end 210 internal changes, provided that the administrator sets up system 210 such that storage back end 250 is allowed to logon to server 240 and issue some commands. This can be done by the administrator through simple, installation-time setup.

Extracted file list 230 is sent by server 240 to storage back end 250 responsive to a request, which may be an automatic request from ADC controller 265. Responsive to receiving file list 230, ADC controller 265 assembles ADC 255 on some spare tapes (or disks, not shown) of tape storage 270 by reading files from tape storage 270 directly and then writing them to the spare tapes (or disks) of storage 270 that are allocated to ADC 255. More specifically, when there are not yet any files in ADC 255, ADC controller 265 simply copies all the files listed in file list 230 to ADC 255. The next time ADC controller 265 gets an updated file list 230 for disk cache 220, ADC controller 265 also gets a directory 275 of the files currently existing in ADC 255, compares the list of files from file list 230 and directory 275, and adds files to ADC 255 or deletes files therefrom responsive to the differences in list 230 and directory 275.

In this building of ADC 255, ADC controller 265 may group file writes to ADC 255 into long sequential writes. That is, ADC controller 265 may cache the files in ADC cache 280, in order to accumulate a number of files. Then ADC controller 265 may group file writes to ADC 255 into long sequential writes. This tends to reduce the time required for writing to ADC 255 and thereby reduce overhead.

The building of ADC 255 is advantageous because if disk cache 220 fails, then once new disks have been put in place in front end 210, disk cache 220 can be bulk-loaded from ADC 255, which is a compact data structure on only a few tapes or disk devices, whereas the entire contents of non-ADC 255 tape storage 270 may be many times the size of ADC 255. Since ADC 255 is only an approximation of disk cache 220, there may be a small percentage of files that need to be restored that are not in ADC 255. For such misses in ADC 255, front end 210 can read files in a conventional manner from (non-ADC 255) storage 270.

Updating ADC when Front End Reads Data from Back End Storage

As previously pointed out, there is overhead associated with building ADC 255. This may impact performance. Even with optimizations such as retrieval sorting, the building of ADC 255 may still be slow. Thus, as mentioned herein above, additional optimization is called for. As previously stated, one such optimization involves using the occasions when front end 210 reads data from back end storage 270 to concurrently update ADC 255. That is, ADC controller 265 writes a file to ADC 255 responsive to front end 210 reading the file from back end storage 270. This is because front end 210 will most likely keep a copy in disk cache 220 for each file that is read from storage back end 250, so this policy tends to minimize the number of reads from the normal tape storage 270 later on. The policy essentially amounts to building and maintaining ADC 255 based on a proactive prediction of what front end 210 writes to disk cache 220. The policy tends to works best when disk cache 220 is not full. When disk cache 220 is full, however, front end 210 will delete some files in disk cache 220 to make room for newly cached files.

As previously mentioned, the deleting of files in disk cache 220 presents additional difficulties for keeping ADC 255 current. That is, the disk cache 220 file replacement policy, which comes into play when disk cache 220 becomes full, is internal to front end 210. So without knowing more about what is happening in front end 210, ADC controller 265 does not necessarily know what files to replace in ADC 255 in order to keep ADC 255 current with disk cache 220. Popular cache replacement policies that front end 210 might be implementing include those based on access frequency and access recency, such as least frequently used (“LFU”) and least recently used (“LRU”). Both replacement policies require knowledge about accesses to disk cache 220 in front end 210, knowledge that typically is not known by back end 250, at least not in sufficient detail to establish a conclusion with certainty.

According to an embodiment of the present invention, by default ADC controller 265 assumes an LRU policy for building and updating ADC 255 cache. That is, ADC controller 265 is initialized with a predetermined assumption for a size limit of disk cache 220. Once ADC controller 265 detects that ADC 255 has reached this predetermined size limit, then responsive to ADC controller 265 detecting a request from front end 210 for reading a file from back end storage 270, ADC controller 265 deletes one or more files in ADC 255, or at least marks one or more files for deletion, starting with the least recently used file and working up toward more recently used files. (That is, if back end 250 storage 270 allocated for storing ADC 255 is full, ADC controller 265 deletes such file or files from ADC 255 until ADC controller 265 has deleted files having a collective size as large as that of the file the front-end requested from the back end. If, on the other hand, back end 250 storage 270 allocated for storing ADC 255 is not full, ADC controller 265 may instead merely mark such file or files to be deleted from ADC 255 at a later time.) This default LRU assumption may not always work well as a prediction of what is happening in front end 210. However, through a cache learning algorithm, ADC controller 265 may improve its prediction over time in many cases, as will be explained herein below.

Updating ADC when Front End Writes to Back End

The above described approach to building ADC 255 works well when there is only read traffic on disk cache 220. However, there may also be write traffic. Such write traffic can originate in two ways. First, files may be created externally and added to system 200. Second, files that already exist on system 200 may be altered externally and written back to system 200. Front end 210 typically has a write back daemon that writes files from a write-back buffer 225 in disk cache 220 periodically to back end storage 250. Front end 210 may be programmed to cause this to happen every few minutes, but it may also be programmed for longer intervals between write backs. Since system 200 might use a portion of disk cache 220 as a write-back buffer 225, these newly created or revised files will be in disk cache 220 for some time before they are written to back end 250 storage.

To cope with such situations, the storage back end 250 must treat writes carefully. Until ADC controller 265 has gained at least a clue about whether front end 210 has a write-back buffer 225 implemented in disk cache 220, ADC controller 265 uses a conservative policy based on a prediction that front end 210 does buffer such writes. Hence, responsive to front end 210 writing a file to back end storage 270, ADC controller 265 also writes a copy of the of the file to ADC 255.

The write back policy of front end 210 also has another implication. That is, if disk cache 220 is full and a new file is created externally and written to system 200 or if an existing file is modified externally, such that the new file is larger, and then the new file is written to system 200, front end 210 must delete something from disk cache 220 to make room for the new file. Thus, once ADC controller 265 detects that ADC 255 has reached its predetermined size limit, ADC controller 265 deletes, or at least marks for later deletion, a file or files in ADC 255 responsive to ADC controller 265 detecting a request from front end 210 for writing a file to back end storage 270, starting with the least recently used file and working up toward more recently used files. That is, ADC controller 265 deletes or marks for deletion such file or files from ADC 255 until ADC controller 265 has deleted or marked a file or files having a collective size as large as that of the front-end-requested file.

The Updating of ADC May be for Both Reads and Writes

Based on the above, it should be understood that storage back end 250 does not distinguish between reads and writes, at least in a default mode, i.e., until such time as ADC controller 265 learns that some distinction is called for, as will be further explained herein below. That is to say, in the default mode ADC controller 265 writes a file to ADC 255 both responsive to front end 210 reading the file from back end storage 270 and responsive to front end 210 writing the file to back end storage 270. Likewise, if ADC controller 265 estimates disk cache 220 is full, then in the default mode ADC controller 265 will delete or mark for deletion one or more files from ADC 255 both in response to front end 210 reading a file from back end storage 270 and responsive to front end 210 writing a file to back end storage 270. Over time, through a learning algorithm described herein below, ADC controller 265 may seek to gain a clue what file replacement policy front end 210 uses and whether front end 210 has a write-back buffer 225 implemented.

Note that in all cases ADC controller 265 may update asynchronously. That is, although ADC controller 265 writes a file to ADC 255 responsive to front end 210 reading a file from back end storage 270 or in response to writing a file to disk cache 220, ADC controller 265 may not do so immediately. Instead, ADC controller 265 may cache the file in an ADC cache 280 so ADC controller can group file writes to ADC 255 into long sequential writes, thereby reducing overhead. This is especially important for an embodiment of the invention such as illustrated, in which spare storage 270 is tape storage.

Dealing with Prediction Error

It should be appreciated from the above that ADC controller 265 may erroneously add files to ADC 255. Likewise, it may erroneously remove files from ADC 255. That is, if the LRU predictive policy of ADC controller 265 described above is incorrect, then ADC controller 265 may delete, or at least mark for deletion, a wrong file from ADC 255 when ADC controller 265 determines disk cache 220 is full. And if the ADC controller 265 write-back predictive policy described above is incorrect, then ADC controller 265 may add a file to ADC 255 although the file is not actually in disk cache 220. To deal with this misprediction, ADC controller 265 also maintains an ADC directory 275 that itemizes files in ADC 255, and sends commands to server 240 from time to time requesting a list 230 of files in disk cache 220. Responsive to obtaining disk cache 220 file list 230, ADC controller 265 compares its own ADC directory 275 and the new disk cache 220 file list 230. The difference between the two indicates what files in disk cache 220 are currently missing in ADC 255 and therefore need to be added to ADC 255, and what files are currently in ADC 255 but have been deleted in disk cache 220 and therefore need to be deleted from ADC 255. Responsive to these differences, ADC controller 265 schedules background jobs to read the files that are currently missing from ADC 255. ADC controller 265 reads the missing files that it needs for ADC 255 from back end storage 270. While ADC controller reads these missing files, normal read streams may continue. ADC controller 265 may also delete unneeded files from ADC 255, particularly if ADC 255 is full.

The less often ADC 255 is updated in response to comparing ADC directory 275 and disk cache 220 file list 230, the greater the potential difference between ADC 255 and disk cache 220. However, since disk cache 220 typically holds several weeks of data, there is generally no need for controller 265 to extract file list 230 very frequently. For example, if file list 230 extraction is done once every twelve hours, in the worst case ADC 255 will be missing cached data accumulated during one half of one day. Given that there is an accumulation of two weeks of data in disk cache 220, this twelve hours of data represents only about 3.6% of the total amount of data in disk cache 220. Thus, in this example, ADC 255 will be at least 96% similar to disk cache 220. From this example, it should be appreciated that extracting file list 230 once or twice a day is sufficient.

Adaptive Learning about Disk Cache

Adaptive learning allows ADC controller 265 to predict more accurately what might be cached in disk cache 220 over time, thereby further minimizing performance overhead for building and maintaining ADC 255. In this connection, ADC controller 265 maintains lists 290 and 295 based on prediction policies of ADC controller 265 and not in response to a comparison ADC controller 265 has made between file list 230 and directory 275. ADC controller 265 compares lists 290 and 295 with disk cache file list 230 whenever it newly obtains file list 230. Based on the comparison, ADC controller 265 determines what proportion of the predictions were correct. ADC controller 265 continues such a prediction policy response to the proportion of the predictions for that policy exceeding a predetermined amount. Otherwise, ADC controller 265 discontinues the prediction policy, and begins using only the extracted disk cache file list 230 to update ADC 255.

List 290 is a predicted cache (“PC”) list. ADC controller 265 adds an indicia of a file to the PC list 290 responsive to ADC controller 265 adding the file to ADC 255, which may be based on the predictive policy of adding a file to ADC 255 responsive to a file being written to back end storage 270, or responsive to a file being read from back end storage 270. (It may, however, be assumed that it is known with certainty that files are added to disk cache 220 responsive to a file being read from back end storage 270, so that no file indicia is added to PC list 290 responsive to a file being read from back end storage 270.)

List 295 is predicted replacement (“PR”) list 295. ADC controller 265 adds an indicia of a file to the PR list 295 responsive to ADC controller 265 either deleting the file from ADC 255, or at least marking the file in ADC 255 for deletion, which may be based on a predicted file replacement policy, such as LRU.

ADC controller 265 considers a prediction to be correct if ADC controller 265 confirms that a file added to ADC 255 is also in disk cache 220 by comparing file list 230 and PC list 290. Likewise, ADC controller 265 considers a prediction to be correct if ADC controller 265 confirms, by comparing file list 230 and PR list 295, that a file deleted from ADC 255, or marked for deletion, has been deleted from disk cache 220.

According to one embodiment of the invention, lists 290 and 295 are reset after each comparison, and thus is only used to measure the prediction of the most recent extraction interval, not the entire access history. In other embodiments, one or both lists 290 and 295 are reset less often, or never.

Example Sequence Illustrating Some of the Above Described Features

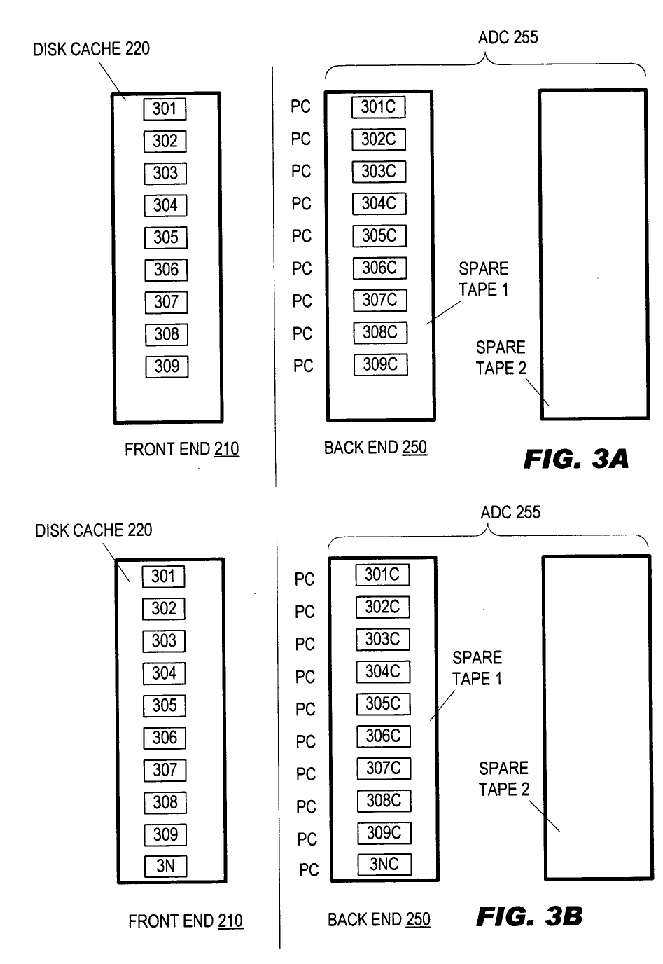

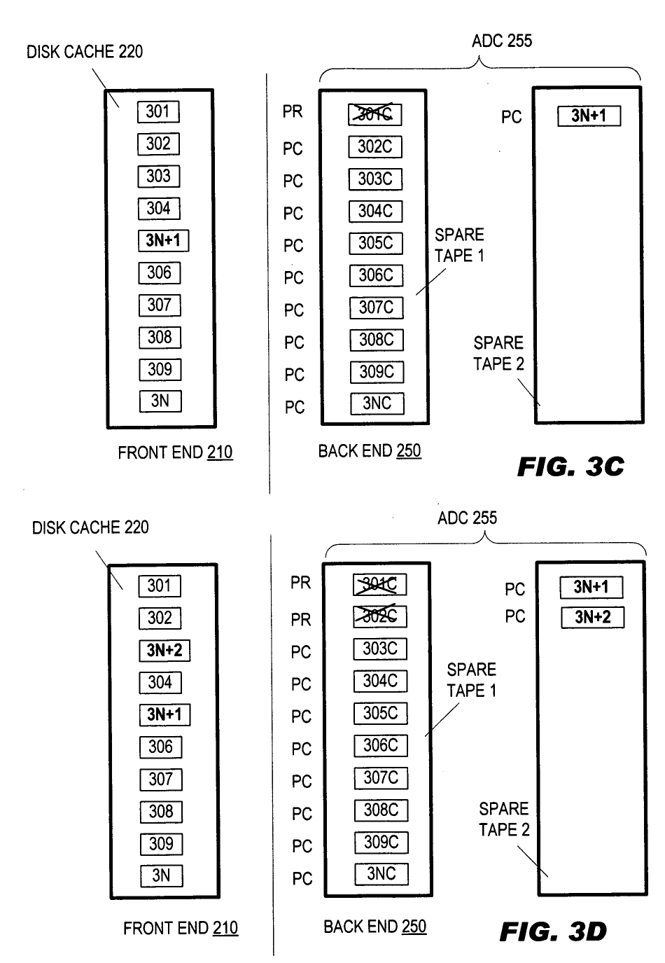

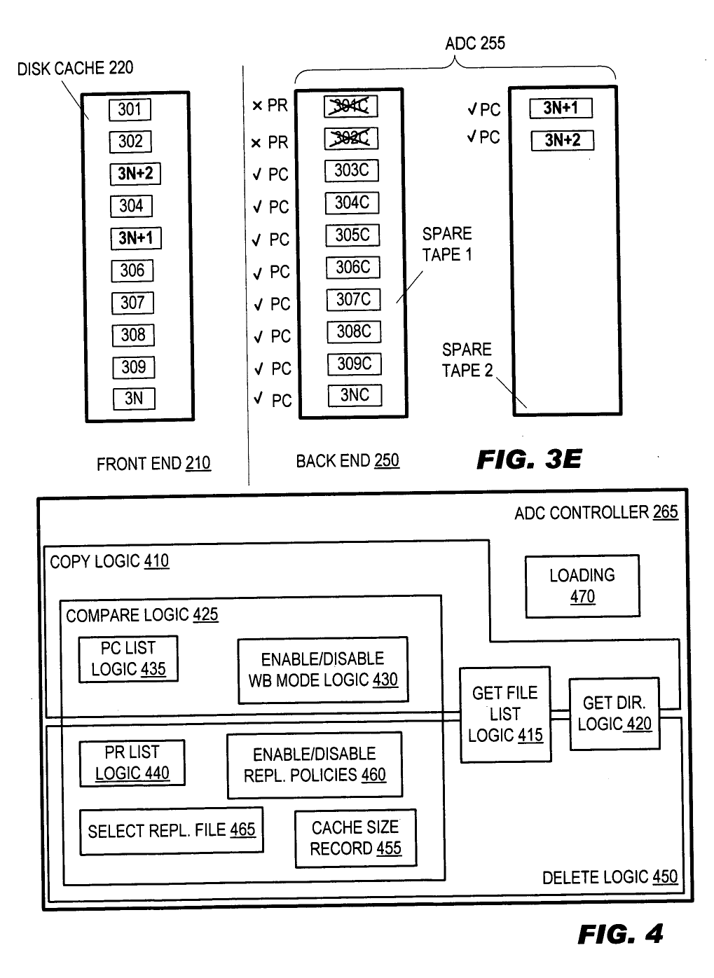

Referring now to FIGS. 3A through 3E, an example time sequence is illustrated, according to an embodiment of the present invention. In FIGS. 3A through 3E, two tapes are allocated for ADC 255, each tape being of the same size as disk cache 220, so that ADC 255 is twice the size of disk cache 220.

In FIG. 3A, a time t1 is illustrated in which files 301 through 309 have been read from back end 250 to front end 210. Accordingly, front end 210 has added files 301 through 309 to disk cache 220, and ADC controller 265 (FIG. 2) has added copies of these files, 301C through 309C, to spare tape 1 of ADC 255. Also, ADC controller 265 has added indicia of files 301C through 309C to the PC list 290 (FIG. 2), which is illustrated figuratively in FIG. 3A by “PC” beside each of the files 301C through 309C.

In FIG. 3B, a later time t2 is illustrated in which additional files through file 3N have been read from back end 250 to front end 210. Accordingly, front end 210 has added these files through 3N to disk cache 220, which fills disk cache 220, and ADC controller 265 (FIG. 2) has added copies of these files to spare tape 1 of ADC 255, which fills spare tape 1. ADC controller 265 has added indicia of the new files through 3N to the PC list 290 (FIG. 2).

In FIG. 3C, a later time t3 is illustrated in which an additional file 3N+1 has been read from back end 250 to front end 210. Accordingly, front end 210 has added file 3N+1 to disk cache 220. Front end 210 had to delete an existing file in order to add file 3N+1, since disk cache 220 is full. As shown, in this instance front end 210 selected file 305 for replacement based on a different replacement policy than the LRU policy assumed by ADC controller 265. However, as shown, ADC controller 265 (FIG. 2) marked file 301C for replacement on tape 1. (ADC controller 265 did not need to actually delete file 301C, since ADC 255 is not yet full.) ADC controller also added an indicator in the PR list 295 for file 301C, removed the indicator in PC list 290 for file 301C, and added an indicator in PC list 290 for file 3N+1, based on an assumed replacement policy. The assumption is actually incorrect, but ADC controller 265 has not yet determined this.

In FIG. 3D, a later time t4 is illustrated in which an additional file 3N+2 has been read from back end 250 to front end 210. Accordingly, front end 210 has added file 3N+2 to disk cache 220. Front end 210 again had to delete an existing file in order to add file 3N+2, since disk cache 220 is still full. In this instance, front end 210 selected file 303 for replacement. Once again ADC controller 265 (FIG. 2) got it wrong and marked file 302C for replacement on tape 1. That is, ADC controller 265 has still not yet determined the error in assumed replacement policy. Also, once again, ADC controller 265 did not need to actually delete file 302C, since ADC 255 is still not yet full. ADC controller added an indicator in the PR list 295 for file 302C, removed the indicator in PC list 290 for file 302C and added an indicator in PC list 290 for file 3N+2, based on an assumed LRU replacement policy.

In FIG. 3E, a later time t5 is illustrated in which ADC controller 265 has newly read file list 230 (FIG. 2) of disk cache 220 and compared list 230 to updated directory 275 (FIG. 2). Also, ADC controller 265 has checked results of the comparison against lists 290 and 295 (FIG. 2) in order to determine accuracy of predictions.

As shown, the comparison indicates that files 301 and 302 are still in disk cache 220, although PR list 295 indicates ADC controller 265 predicted they were replaced therein. In this instance, the proportion of incorrect items on list 295 is 100%. In the illustrated embodiment of the present invention, ADC controller 265 has a predetermined threshold of 30% errors for PR list 295. Thus, since 100% error rate exceeds the 30% threshold, this triggers a conclusion by ADC controller that the replacement policy assumption was wrong. ADC controller 265, accordingly, changes to another replacement policy assumption, such as First-In-First-Out, for the next interval, i.e., before reading list 230 again.

In computing the proportion of errors in PC list 290, ADC controller 265, checks to see if each file in PC list 290 is also in front end disk cache 220. If so, then there is no error. Likewise, ADC controller 265, checks to see if each file in front end disk cache 220 is also in PC list 290. As shown in FIG. 3E, the comparison indicates the files ADC controller 265 predicted, i.e., the files PC list 290 indicates should be in disk cache 220, are in disk cache 220, except files 303 and 305. However, files 303 and 305 are not in disk cache 220 because of the above described two errors in PR list 295. In computing the proportion of errors in PC list 290, ADC controller 265, therefore, takes this into account, i.e., does not count the absence of files 303 and 305 from disk cache 220 as errors attributable to PC list 290. The number errors divided by the total number of files in the front end cached file list is the proportion of errors, according to an embodiment of the present invention. Thus, in the illustrated instance, PC list 290 has 0% errors. In the illustrated embodiment of the present invention, ADC controller 265 has a predetermined threshold of 20% errors for PC list 290. Thus, the predictive policy for adding files to disk cache 220 is confirmed since the proportion of errors is below the threshold. Accordingly, the predictive policy is maintained in the next interval.

Logic for ADC

Referring now to FIG. 4, logic for aspects of ADC controller 265 is shown, according to an embodiment of the present invention, which is described in conjunction with FIG. 2. ADC controller 265 includes copy logic 410 for copying substantially all the cached files to the non-ADC portion of storage 270. Thus, the non-ADC portion of storage 270 includes original files, cache 220 includes a first copy of a subset of those files, and ADC 255 of storage 270 includes a second copy of substantially all the ones of the original files that are on cache 220.

ADC controller 265 also includes loading logic 470 for loading the files from ADC 255 to cache 220 in response to a loss of ones of the files in cache 220. ADC 255 is predetermined to be a sequential, set-aside portion of storage 270. Also, aside from errors due to uncertainty about whether the front end 210 caches write-backs and about what replacement policy front end 210 uses, the ADC 255 is predetermined not to have substantially any other files besides those in cache 220. And, as explained herein, the directory 275 of files in ADC 255 is compared periodically to the list 230 of files in cache 220, and ADC 255 is accordingly updated. As explained elsewhere herein, if ADC 255 is the same size as cache 220 and ADC 255 is updated in this manner twice a day, and cache 220 holds 2 weeks worth of data, the files of ADC 255 and the files of cache 220 will be at least 90% the same. Thus, for such an embodiment of the invention, the files in ADC 255 are in a data structure consisting substantially of the copies of the files in cache 220 and the loading of the copies of the files in ADC 255 to cache 220 can be by bulk-loading. Likewise, even in an embodiment of the invention in which ADC 255 is larger than cache 220, ADC controller 265 may reorganize files therein periodically so the files in ADC 255 that are not marked for deletion are sequentially located in ADC 255 and are therefore in a data structure consisting substantially of the copies of the files in cache 220.

ADC controller 265 also includes get file list logic 415 for getting file list 230, and get directory logic 420 for getting directory 275. Copy logic 410 includes compare logic 425 for the herein described comparing of file list 230 and directory 275, responsive to passage of a certain time interval, and the copying by copy logic 410 includes copying responsive to such a comparison. Copy logic 410 also includes enable/disable write-back mode logic 430 for enabling a write-back-to-main-storage mode. Responsive to this mode being enabled the copying of the cached files by copy logic 410 includes copying ones of the files responsive to writing the ones of the files from cache 220 to ADC 255. Enable/disable write-back mode logic 430 disables the write-back-to-main-storage mode responsive to the comparing indicating that files are not written to cache 220 except from the non-ADC storage 270, i.e., responsive to the comparing indicating that a write-back cache is not implemented in cache 220.

A delete logic 450 of ADC controller 465 includes, or at least has access to, a memory 455 for storing a record of the size of cache 220. This size is predetermined. ADC controller 465 also includes a select replacement files logic 465 for selecting for replacement one or more of the copies of the files in ADC 265 responsive to reading a file from the non-ADC portion of storage 270 if an accumulated size of a file that is read and files already stored in ADC exceeds the cache size. The selecting for replacement is further responsive to a currently predicted replacement policy for the cache, as explained elsewhere herein. ADC controller 465 also includes enable/disable replacement policies logic 460 for disabling the currently predicted replacement policy and enabling a second predicted replacement policy for cache 220 responsive to the comparing of file list 230 and directory 275 indicating that the first predicted replacement policy was incorrect.

Copy logic 410 also includes predicted cached list logic 435 for adding a record of a file to predicted cached list 290 responsive to adding the file to ADC 255. The adding is further responsive to the file being written to or read from non-ADC storage 270. Delete logic 450 includes predicted replacement list logic 440 for adding a record of a file to predicted replacement list 295 responsive to deleting a file, or at least marking the file for deletion, from ADC 255 based on a predicted file replacement policy of the cache.

An Enhancement

In an enhancement, ADC controller 265 maintains a distinction between reads and writes for predicted disk cache list 290. That is, ADC controller 265 divides predicted disk cache list 290 into a read-based portion 290R of list 290 and a write-based portion 290W. The read-based portion 290R contains a list of all the files that ADC controller 265 added to ADC 255 due to reading from back end storage 270. The write-based portion 290W contains all the files that ADC controller 265 added to ADC 255 due to writing from disk cache 220 to back end storage 270. Likewise, ADC controller 265 divides predicted replacement list 295 into a read-based portion 295R of list 295 and a write-based portion 295W. The read-based portion 295R contains a list of all the files that ADC controller 265 deleted from ADC 255, or at least marked for deletion, due to reading from back end storage 270. The write-based portion 295W contains all the files that ADC controller 265 deleted from ADC 255, or at least marked for deletion, due to writing from disk cache 220 to back end storage 270. For this enhancement, ADC controller 265 compares each portion 290R, 290W, 295R and 295W to file list 230 separately.

More specifically, adding files to ADC 255 responsive to the files being read from back end storage 270 is assumed to almost certainly have been a correct policy of ADC controller 265. However, it is initially not known whether it was a correct policy of ADC controller 265 to add files to ADC 255 responsive to files being written to back end storage 270, which is based on an assumption about implementation of a write-back buffer 225 in disk cache 220. Therefore, according to an embodiment of the present invention, ADC controller 265 uses the write-based portion 290W of PC list 290 to select whether or not to continue adding files to ADC 255 responsive to files being written to storage 270. That is, in response to the proportion of the predictions that were correct for the predicted disk cache list 290 write-based portion 290W, ADC controller 265 selects whether or not to continue adding files to ADC 255 responsive to files being written to storage 270. However, ADC controller 265 does not use the read-based portion 290R of PC list 290 to select whether or not to continue adding files to ADC 255. Thus, referring to FIG. 4 again, in an enhanced version of copy logic 410 the adding of files to cache 220 includes adding a record of a file to a read-based portion of predicted cached list 490 responsive to the file being written to non-ADC storage 270, in which case enable/disable write-back mode logic 430 includes logic for comparing a write-based portion of predicted cached list 290 to results of the comparing of file list 230 and directory 275.

Conversely, ADC controller 265 selects which predictive policy to use for deleting files from ADC 255 in response to the proportion of the predictions that were correct for the PR list 295 read-based portion 295R. But, as previously state, it is initially not known whether it was a correct policy of ADC controller 265 to add files to ADC 255 responsive to files being written to back end storage 270, which is based on an assumption about implementation of a write-back buffer 225 in disk cache 220. Therefore, ADC controller 265 does not select which predictive policy to use for deleting files from ADC 255 in response to the proportion of the predictions that were correct for the PR list 295 write-based portion 295W. Thus, referring to FIG. 4 again, in an enhanced version of delete logic 450 the deleting of files from ADC 255 includes adding a record of a file to a read-based portion of predicted replacement list 495 responsive to the file being read from non-ADC storage 270, in which case enable/disable write-back mode logic 430 includes logic for comparing a write-based portion of predicted cached list 290 to results of the comparing of file list 230 and directory 275.

Bulk-Loading of Disk Cache after Disk Failure

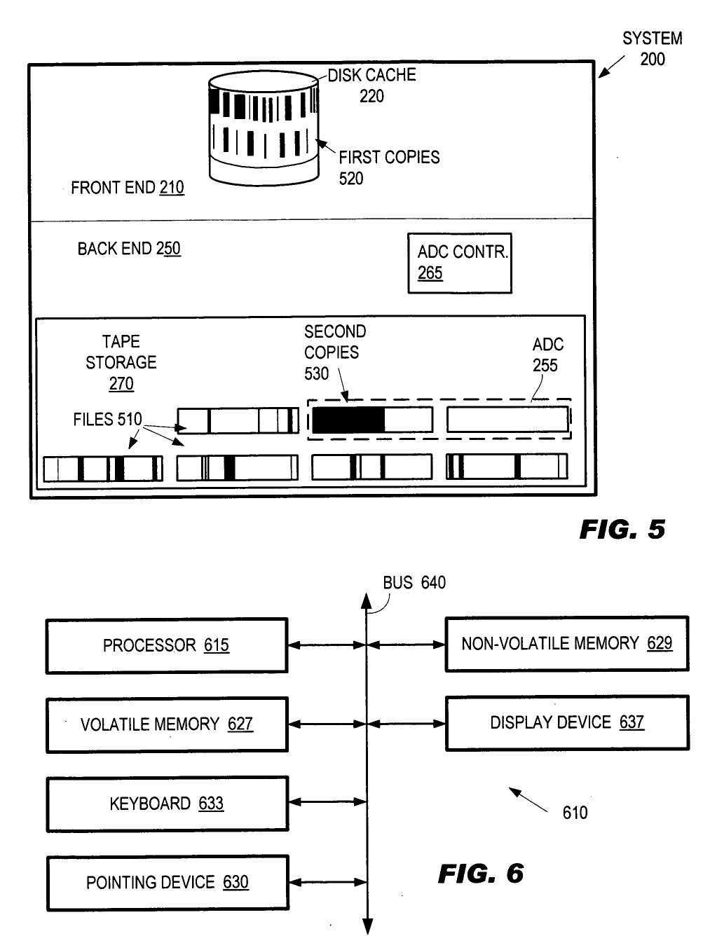

It should be understood from the foregoing, and by reference now to FIG. 5, that when disk cache 220 fails, disk cache 220 can be restored by bulk-loading from ADC 255 once the failed disks are replaced. As shown in FIG. 5, storage system 200 has disk cache 220 and main storage 270 for longer term storage. Main storage 270 of system 200 has first files 510 (indicated by black segments) stored therein. Front end 210 obtains first copies 520 (indicated by black segments) of a subset of first files 510 from main storage 270 and caches them in cache 220 responsive to user requests for ones of the first files 510. ADC controller 265 copies, in a predetermined, set-aside portion of the main storage 270, i.e., in ADC 255, substantially all the cached files, i.e., second copies 530 (indicated by black segments) of first copies 520, so that main storage 270 includes the first files 510 and second copies 530 of substantially all of the subset of first files 510, wherein second copies 530 are in a more compact data structure in ADC 255 than is the subset of first files 510 in the non-ADC portion of main storage 270, as shown. Specifically, ADC 255 may be limited to second copies 530 in substantially sequential locations with substantially no other files therein, or at least limited to second copies 530 plus replaced ones of first files 510 that have not yet been deleted. Note that ADC controller 265 may compact second copies 530 from time to time, which may include deleting ones of first files 510 that are no longer in disk cache 220, such as files 303C and 305C in FIG. 3E, for example, and relocating remaining files to eliminate discontinuities, so that all remaining files in ADC 255 are in substantially continuous, sequential segments of memory. Thus ADC controller 265 may load ones of the second copies 530 of the subset of the first files 510 to cache 220 from ADC 255 in response to a loss of ones of files 520 in cache 220.

Commonly, front end 210 already has some form of bulk-loading capability for prefetching, so there is no need for additional changes in CM. Otherwise, storage back end 250 can provide a facility for front end 210 to bulk-load ADC 255 to disk cache 220. Since ADC 255 is on a few tapes or disk devices, the bulk-loading can be done very quickly in comparison to existing solutions. Normal I/O requests can be issued concurrently with bulk-loading disk cache 120. If the I/O requests have hits in disk cache 220, they can be served right away. Otherwise, storage controller 265 checks them against ADC 255 when the requests arrive at storage back end 250. If they are ADC 255 hits, storage controller 265 serves the I/O requests from ADC 255. Otherwise, storage controller 265 handles them as normal requests for back end storage 270. Since ADC 255 closely approximates disk cache 220, the proportion of ADC 255 misses should be small. So overall, system 200 performance should be improved.

Miscellaneous Remarks and Other Variations

An arrangement has been described herein that ensures fast refresh of disk cache after failures. The arrangement includes a mechanism that collects disk cache information without internal changes to the front end of a storage system. The collected information is used by the storage back end together with the observed access information to quickly assemble an approximate copy of disk cache on cheap and low-cost storage devices in the storage back end with little additional performance overhead. An adaptive learning algorithm is incorporated to allow the storage back end to predict what is in the disk cache more accurately over time to further speed up building and maintaining the disk cache. The combination of the collected disk cache information, the observed usage patterns, and adaptive learning algorithm results in a low-cost, efficient, simple, compact, and highly accurate “approximate disk cache” data structure in the storage back end. It should be understood from the foregoing, that the invention is particularly advantageous because the assembled approximate disk cache can be used to facilitate fast disk cache restoration. There is minimal additional management activity required, so the overall system is easy to use and easy to manage. The hardware cost is also fractional, since only spare resources in the storage back end are used.

The description of the present embodiment has been presented for purposes of illustration, but is not intended to be exhaustive or to limit the invention to the form disclosed. Many modifications and variations will be apparent to those of ordinary skill in the art. For example, it should be understood that while the present invention has been described in the context of an ADC controller implemented by a processor application-specific integrated circuitry, those of ordinary skill in the art will appreciate that the logic of the storage system described herein may be implemented in the context of a fully functioning data processing system. Moreover, the processes of the present invention are capable of being distributed in the form of a computer readable medium of instructions. Such computer readable medium may have a variety of forms. The present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

Referring now to FIG. 6 an embodiment of the invention is illustrated in which, logic for the storage system described herein, which may include an ADC controller, takes the form of a computer system 610. It should be understood that the term “computer system” is intended to encompass any device having a processor that executes instructions from a memory medium, regardless of whether referred to in terms of a microcontroller, personal computer system, mainframe computer system, workstation, server, or in some other terminology. Computer system 610 includes a processor 615, a volatile memory 627, e.g., RAM and a nonvolatile memory 629, e.g., ROM. Memory 627 and 629 store program instructions (also known as a “software program”), which are executable by processor 615, to implement various embodiments of a software program in accordance with the present invention. Processor 615 and memories 627 and 629 are interconnected by bus 640. An input/output adapter (not shown) is also connected to bus 640 to enable information exchange between processor 615 and other devices or circuitry. System 610 may also include a keyboard, pointing device, e.g., mouse, nonvolatile memory, e.g., ROM, hard disk, floppy disk, CD-ROM, and DVD, and a display device.

Various embodiments implement the one or more software programs in various ways, including procedure-based techniques, component-based techniques, and/or object-oriented techniques, among others. Specific examples include XML, C, C++ objects, Java and commercial class libraries. Those of ordinary skill in the art will appreciate that the hardware in FIG. 6 may vary depending on the implementation. For example, other peripheral devices may be used in addition to or in place of the hardware depicted in FIG. 6. The depicted example is not meant to imply architectural limitations with respect to the present invention.

The terms “logic” and “memory” are used herein. It should be understood that these terms refer to circuitry that is part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The description herein mentioned HSM technology, however, it is within the spirit and scope of the invention to encompass an embodiment wherein the teachings herein are applied to other kinds of technology.

It has been explained herein above that through comparing prediction lists and extracted disk cache lists, the storage back end can adaptively learn over time to predict what may be cached in disk cache and that this tends to minimize overhead for building ADC cache and improve overall system performance. The ADC controller learning algorithm can be improved further by incorporating other knowledge. For instance, if it is observed that sequential files of groups of files are often not cached by CM disk cache, the storage back end can automatically, selectively turn off some sequential read caching.

ADC 255 in storage back end 250 can be configured to be essentially the same size as disk cache 220, or a little bigger. A bigger ADC 255 will reduce ADC 255 misses during disk cache 220 restoration. Of course, a bigger ADC 255 requires more spare storage resources. Choices about the ADC size tradeoff may be made manually by an administrator, or may be made dynamically by ADC controller 265 itself. For instance, if the spare resource is low, ADC controller 265 may reduce the storage allocated for ADC 255.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention.

Unless clearly and explicitly stated, the claims that follow are not intended to imply any particular sequence of actions. The inclusion of labels, such as a), b), c) etc., for portions of the claims does not, by itself, imply any particular sequence, but rather is merely to facilitate reference to the portions.

What is claimed is:

1. A method in a storage system having a cache and a main storage for longer term storage, with the main storage of the system having first files stored therein, the method comprising:
a) caching first copies of a subset of the first files in the cache responsive to user requests for ones of the first files;
b) copying, in a predetermined, set-aside portion of the main storage, substantially all the cached files, so that the main storage includes the first files and second copies of substantially all of the subset of the first files, wherein the second copies are in a more compact data structure in the set-aside portion than is the subset of the first files in a non-set-aside portion of the main storage; and
c) loading ones of the second copies of the subset of the first files to the cache from the set-aside portion of the main storage in response to a loss of ones of the files in the cache.

2. The method of claim 1, wherein the files in the set-aside portion of the main storage are in a data structure consisting substantially of the second copies of the subset of the first files, and wherein the loading of the second copies of the subset of the files to the cache from the set-aside portion of the main storage is by bulk-loading.

3. The method of claim 1, wherein the caching in a) includes reading the requested files from the non-set-aside portion of the main storage, and wherein the copying of the cached files in b) includes writing the first copies to the cache responsive to the reading; and
wherein b) includes:
b1) comparing a file list of the first copies and a directory of the second copies responsive to passage of a certain time interval, and the copying in b) includes copying responsive to such a comparison.

4. The method of claim 3, wherein for an enabled write-back-to-main-storage mode, the copying of the cached files in b) includes copying ones of the files responsive to writing the ones of the files from the cache to the non-set-aside portion of the main storage, and wherein the method includes:
disabling the write-back-to-main-storage mode responsive to the comparing in b1) indicating that files are not written to the cache except from the main storage.

5. The method of claim 3, wherein the cache has a predetermined size and the method includes:
storing a record of the cache size;
selecting for replacement one or more of the second copies of the files in the set-aside portion of the main storage responsive to reading a file from the non-set-aside portion of the main storage if an accumulated size of the read file and files already stored in the set-aside portion of the main storage exceeds the cache size, wherein the selecting for replacement is further responsive to a first predicted replacement policy for the cache; and
disabling the first predicted replacement policy and enabling a second predicted replacement policy for the cache responsive to the comparing in b1) indicating that the first predicted replacement policy was incorrect.

6. The method of claim 3, including:
adding a record of a file to a predicted cached list responsive to adding the file to the set-aside portion of the main storage, wherein the adding is responsive to the file being written to the set-aside portion of the main storage or to the file being read from the set-aside portion of the main storage and
adding a record of a file to a predicted replacement list responsive to deleting the file or at marking the file for deletion from the set-aside portion of the main storage, wherein the deleting is based on a predicted file replacement policy of the cache.

7. The method of claim 4, including:
adding a record of a file to a predicted cached list responsive to adding the file to the set-aside portion of the main storage, wherein the adding is responsive to the file being written to the set-aside portion of the main storage or to the file being read from the set-aside portion of the main storage wherein the adding includes adding the record to a write-based portion of the predicted cached list responsive to the file being written to the set-aside portion of the main storage and wherein the comparing in b1) includes comparing the write-based portion of the predicted cached list to results of the comparing of the file list of the first copies and the directory of the second copies.

8. The method of claim 5, including:
adding a record of a file to a predicted replacement list responsive to deleting the file or at marking the file for deletion from the set-aside portion of the main storage, wherein the deleting is based on a predicted file replacement policy of the cache, wherein the adding includes adding the record to a read-based portion of the predicted replacement list responsive to a file being read from the set-aside portion of the main storage and wherein the comparing in b1) includes comparing the read-based portion of the predicted replacement list to results of the comparing of the file list of the first copies and the directory of the second copies.

9. A storage system, comprising:
main storage having first files therein on a tangible, computer-readable medium;
a cache having cached files stored therein on a tangible, computer-readable medium, the cached files being first copies of a subset of the first files of the main storage; and
a controller for the main storage having copy logic operable to copy, into a predetermined, set-aside portion of the main storage, substantially all the cached files, such that the main storage includes the first files and second copies of substantially all of the subset of the first files, wherein the second copies are in a more compact data structure in the set-aside portion of the main storage than is the subset of the first files in a non-set-aside portion of the main storage and ones of the second copies of the subset of the first files may be loaded to the cache from the set-aside portion of the main storage in response to a loss of ones of the files in the cache.

10. The system of claim 9, wherein the files in the predetermined portion of the main storage are in a data structure consisting substantially of the second copies of the subset of the first files so that the loading of the second copies of the subset of the files to the cache from the predetermined portion of the main storage may be bulk-loading.

11. The system of claim 9, wherein the caching includes reading the requested files from the non-set-aside portion of the main storage, and the copy logic is operable to perform the copying of the cached files to the cache responsive to the reading, and wherein the controller includes compare logic operable for comparing a file list of the first copies and a directory of the second copies responsive to passage of a certain time interval, and certain of the copying by copy logic is responsive to such a comparison.

12. The system of claim 11, wherein for an enabled write-back-to-main-storage mode, the copying by copy logic includes copying ones of the files responsive to writing the ones of the files from the cache to the non-set-aside portion of the main storage, and wherein the controller includes enable/disable write-back mode logic for disabling the write-back-to-main-storage mode responsive to the comparing by compare logic indicating that files are not written to the cache except from the main storage.

13. The system of claim 11, wherein the cache has a predetermined size and the system includes:
a cache size memory for storing a record of the cache size, and wherein the controller includes:
delete logic having select logic operable to select for replacement one or more of the second copies of the files in the set-aside portion of the main storage responsive to a file being read from the non-set-aside portion of the main storage if an accumulated size of the read file and files already stored in the set-aside portion of the main storage exceeds the cache size, wherein the selecting for replacement is further responsive to a first predicted replacement policy for the cache, and wherein the delete logic has enable/disable replacement policies logic operable to disable the first predicted replacement policy and enable a second predicted replacement policy for the cache responsive to the comparing by compare logic indicating that the first predicted replacement policy was incorrect.

14. The system of claim 11, wherein the controller includes:
predicted cache list logic operable to add a record of a file to a predicted cached list responsive to the copy logic adding the file to the set-aside portion of the main storage, wherein the adding is responsive to the file being written to the set-aside portion of the main storage or to the file being read from the set-aside portion of the main storage and
predicted replacement list logic operable to add a record of a file to a predicted replacement list responsive to the delete logic deleting the file or at least marking the file for deletion from the set-aside portion of the main storage, wherein the deleting is based on a predicted file replacement policy of the cache.

15. The system of claim 12, wherein the controller includes:
predicted cache list logic operable to add a record of a file to a predicted cached list responsive to the copy logic adding the file to the set-aside portion of the main storage, wherein the adding is responsive to the file being written to the set-aside portion of the main storage or to the file being read from the set-aside portion of the main storage wherein the adding includes adding the record to a write-based portion of the predicted cached list responsive to the file being written to the set-aside portion of the main storage and wherein the comparing by compare logic includes comparing the write-based portion of the predicted cached list to results of the comparing of the file list of the first copies and the directory of the second copies.

16. The system of claim 13, wherein the controller includes:
predicted replacement list logic operable to add a record of a file to a predicted replacement list responsive to the delete logic deleting the file or at least marking the file for deletion from the set-aside portion of the main storage, wherein the deleting is based on a predicted file replacement policy of the cache, wherein the adding includes adding the record to a read-based portion of the predicted replacement list responsive to a file being read from the set-aside portion of the main storage and wherein comparing the read-based portion of the predicted replacement list to results of the comparing of the file list of the first copies and the directory of the second copies.

17. A computer program product for controlling certain storage in a storage system having a cache and a main storage for longer term storage, with the main storage of the system having first files stored therein and first copies of a subset of the first files being cached in the cache responsive to user requests for ones of the first files, the computer program product having instructions stored on a tangible, computer-readable medium, the instructions comprising:
instructions for copying, in a predetermined, set-aside portion of the main storage, substantially all the cached files, so that the main storage includes the first files and second copies of substantially all of the subset of the first files, wherein the second copies are in a more compact data structure in the set-aside portion than is the subset of the first files in a non-set-aside portion of the main storage; and
instructions for loading ones of the second copies of the subset of the first files to the cache from the set-aside portion of the main storage in response to a loss of ones of the files in the cache.

18. The computer program product of claim 17, wherein the copying of the files to the set-aside portion of the main storage includes writing the files in a data structure consisting substantially of the second copies of the subset of the first files, and wherein the loading of the second copies of the subset of the files to the cache from the set-aside portion of the main storage is by bulk-loading.

19. The computer program product of claim 17, wherein the caching in includes reading the requested files from the non-set-aside portion of the main storage, and wherein the copying of the cached files includes writing the first copies to the cache responsive to the reading, the computer program product including instructions for comparing a file list of the first copies and a directory of the second copies responsive to passage of a certain time interval, and the copying includes copying responsive to such a comparison, wherein for an enabled write-back-to-main-storage mode, the copying of the cached files in includes copying ones of the files responsive to writing the ones of the files from the cache to the non-set-aside portion of the main storage, and wherein the computer program product includes instructions for disabling the write-back-to-main-storage mode responsive to the comparing in b1) indicating that files are not written to the cache except from the main storage.

20. The computer program product of claim 19, wherein the cache has a predetermined size and the computer program product includes:
instructions for storing a record of the cache size;
instructions for selecting for replacement one or more of the second copies of the files in the set-aside portion of the main storage responsive to reading a file from the non-set-aside portion of the main storage if an accumulated size of the read file and files already stored in the set-aside portion of the main storage exceeds the cache size, wherein the selecting for replacement is further responsive to a first predicted replacement policy for the cache; and
instructions for disabling the first predicted replacement policy and enabling a second predicted replacement policy for the cache responsive to the comparing in b1) indicating that the first predicted replacement policy was incorrect.
